(19) United States
(12) Patent Application Publication
(10) Pub. No.: US 2021/0374466 A1
(43) Pub. Date: Dec. 2, 2021

(54) WATER LEVEL MONITORING METHOD BASED ON CLUSTER PARTITION AND SCALE RECOGNITION

(71) Applicant: ZHEJIANG UNIVERSITY, Hangzhou (CN)

(72) Inventors: Feng Lin, Hangzhou (CN); Yuzhou Lu, Hangzhou (CN); Zhentao Yu, Hangzhou (CN); Tian Hou, Hangzhou (CN); Zhiguan Zhu, Hangzhou (CN)

(21) Appl. No.: 17/331,663

(22) Filed: May 27, 2021

Related U.S. Application Data
(63) Continuation of application No. PCT/CN2020/122167, filed on Oct. 20, 2020.

(30) Foreign Application Priority Data
May 26, 2020 (CN) 202010454858.0

(51) Int. Cl. G06K 9/62; G06T 7/136; G06T 7/194; G06F 17/11

(52) U.S. Cl. CPC G06K 9/6223; G06K 9/6256; G06F 17/11; G06T 7/136; G06T 7/194; G06K 9/6276

(57) ABSTRACT

Disclosed is a water level monitoring method based on cluster partition and scale recognition. The water level monitoring method comprises the following steps: 1) obtaining an original image at time t from a real-time monitoring video; 2) intercepting a water gauge area in the original image, and marking an end of the water gauge as a position of the water level; 3) binarizing an image of the water gauge area, and dividing the image of water gauge area processed by a cluster method into several subsections according to three sides of symbol “E”; 4) recognizing a content of each subsections, and obtaining a numerical value in a last subsection containing numbers prior to an area where the water level is located; and 5) calculating and displaying the water level according to the height of the subsections and the numerical value obtained in step 4).

### CROSS-REFERENCE TO RELATED APPLICATIONS

This application is a continuation of and claims priority to International (PCT) Patent Application No. PCT/CN2020/122167, filed on Oct. 20, 2020, entitled “WATER LEVEL MONITORING METHOD BASED ON CLUSTER PARTITION AND SCALE RECOGNITION,” which claims foreign priority of Chinese Patent Application No. 202010454858, filed on May 26, 2020 in the China National Intellectual Property Administration (CNIPA), the entire contents of which are hereby incorporated by reference in their entireties.

### TECHNICAL FIELD

The present disclosure relates to the field of water level monitoring, and in particular to a water level monitoring method based on cluster partition and scale recognition.

### BACKGROUND

Water level monitoring is an important monitoring index for rivers, reservoirs and other water bodies, and it is of great significance. In the prior art, conventional water level monitoring methods include sensor monitoring and manual water level monitoring. Among them, the manual monitoring using the water level gauge adopts video image to monitor the water level in the river and irrigation canal in real time. Then the data such as the water level of the water gauge are recorded regularly by manually reading the video.

The disadvantages of manually recording the water level are: 1. real-time recording of the water level cannot be achieved; 2. the increase in monitoring points will directly lead to an increase in labor costs. However, one server can replace the labor of multiple people to monitor the water level in real time by using the computer vision to solve the problem of reading water gauge. There are already many methods for automatically recognizing water gauges, among which deep learning methods have been widely used due to their characteristics.

Chinese patent publication No. CN109145830A discloses a smart water gauge recognition method, which intercepts the target area of the water gauge image to be recognized, and then uses convolutional neural network learning to recognize the scale of the water gauge. Chinese patent publication No. CN110427933A discloses a deep learning-based water gauge recognition method. This method realizes the positioning of the water gauge through the target detection algorithm of deep learning, and steps including partially adjusting the positioning results, then using character recognition, etc. to calculate the final water level value. Chinese patent publication No. CN108318101A discloses a water gauge water level video intelligent monitoring method and system based on a deep learning algorithm. This method includes the steps of video acquisition, video frame processing, water level line recognition, and water level measurement. However, these methods all are realized by processing the image data, which affects the recognition accuracy.

Chinese patent publication No. CN110472636A discloses a symbol scale E recognition method based on deep learning. The scale value is calculated by recognizing the work E, but its accuracy is relatively low. Chinese patent publication No. CN109903303A discloses a method for extracting ship waterline based on convolutional neural network. This method only needs to identify the ship's waterline, not the water gauge area, and does not need to identify the angle of the waterline, etc. Nor can it identify the specific scale. Chinese patent publication No. CN110619328A discloses an intelligent recognition method for ship water gauge readings based on image processing and deep learning. This method intercepts the water gauge interest area and inputs the intercepted water gauge interest area into the convolutional neural network for recognition for determining the water gauge reading. However, it did not explain how to determine the water gauge area in the image.

In the process of water level recognition, some of the above methods only consider the turbid and opaque water quality. When the water quality is clear, the water color and the water level line are not easy to identify. As such, there will be a relatively large error, and therefore limits its application. Moreover, water level monitoring points such as river courses and irrigation canals are all outdoor environment, and the site has a greater impact on the erection of monitoring cameras. Therefore, there are big differences in different monitoring points, the shooting distance of the water gauge, the shooting angle, and the image quality. Outdoor water gauges are also susceptible to factors such as light and occlusion, which increases the difficulty of water gauge recognition.

### SUMMARY OF THIS INVENTION

An object of the present disclosure is to provide a water level monitoring method based on cluster partition and scale recognition. The water level monitoring method based on cluster partition and scale recognition as provided may avoid complex feature extraction and data reconstruction processes in conventional recognition methods.

In order to arrive at the object, the provided water level monitoring method based on cluster partition and scale recognition comprises the following steps:

1) obtaining an original image at time t from a real-time monitoring video;

2) intercepting a water gauge area in the original image, and marking an end of the water gauge as a position of the water level;

3) binarizing an image of the water gauge area, and dividing the image of water gauge area processed by a cluster method into several subsections according to three sides of symbol “E”;

4) recognizing a content of each subsections, and obtaining a numerical value in a last subsection containing numbers prior to an area where the water level is located; and

5) calculating and displaying the water level according to the height of the subsections and the numerical value obtained in step 4).

Optionally, in one embodiment, semantic segmentation algorithm Deeplab V3+ are used to divide the original image, comprising:

2-1) obtaining a training set, and performing data enhancement and normalization processing on images in the training set;

2-2) inputting the processed image into Deeplab V3+ semantic segmentation model for training, and outputting a first segmentation result;

2-3) evaluating the first segmentation result to obtain a segmentation model of the water gauge area; and

2-4) inputting the original image into the segmentation model of the water gauge area to obtain a second segmentation result, and correcting the second segmentation result.

Optionally, in one embodiment, in the step 2-3), when evaluating the first segmentation result, MIoU (Mean Intersection over Union) is adopted according to the characteristics of the image, wherein IoU (Intersection over Union) refers to a ratio of the area of the intersection of the two point sets to the area of the union of the two point sets; MIoU is the mean value of the IoU of the true value and the predicted value of each category. MIoU is shown as following equation:

$$MIoU = \frac{1}{k + 1} {\sum }_{i = 0}^{k} \frac{{P}_{ii}}{{\sum }_{j = 0}^{k} {P}_{ij} + {\sum }_{j = 0}^{k} {P}_{ji} - {P}_{ii}} .$$

The segmentation result is classified by the evaluation result.

Optionally, in one embodiment, in step 3), OTSU is adopted to binarize the image of the water gauge area, comprising:

dividing a pixel into a foreground 1 and a background 0 according to a threshold T, wherein a calculation equation for the variance between classes is:

Var=N₁(μ−μ₁)²+N₀(μ−μ₀)²;

herein, N₁ is the number of pixels in the foreground; μ₁ is a mean value of the pixels in the foreground; N₀ is the number of pixels in the background; μ₀ is a mean value of the pixels in the background; μ is a mean value of all pixels;

traversing the threshold value from 0 to 255 by traversal methods; recording a threshold value T when the variance Var reaches maximum; calculating the threshold value T by OTSU method; and binarizing the image of the water gauge area with the threshold value.

Optionally, in one embodiment, the step 3) further comprises:

3-1) counting the number of foreground pixels on the y-axis according to the binarization result;

3-2) marking the area corresponding to the category with a larger number of foreground pixels as black, and marking the area with a smaller umber of foreground pixels as white;

3-3) calculating the spacing of all black areas, wherein the spacing between the three sides of the symbol “E” is less than the spacing between the numerical symbols;

3-4) performing K=2 mean clustering on all spacings, and obtaining two cluster centers; wherein the two cluster centers are the spacing between adjacent “E” symbols and the three-side spacing of “E” symbols;

3-5) combining a black borders of the three sides that belong to the “E” symbol into one area and marking the area as black to complete the segmentation of the several subsections consisting of the black areas and white areas.

Optionally, in one embodiment, K-means clustering algorithm is adopted as a key algorithm in the step 3-4). More specifically, the step 3-4) comprises:

a) randomly selecting K points from a set of input points (pixel points) as cluster centers;

b) calculating the distance from all points to the K cluster centers;

c) classifying each point and its nearest cluster center into one category;

d) in each new category, finding the point with the smallest distance within the category as the new cluster center; and

e) repeating steps b-d until the number of iterations is completed, and iterate to the end of the set value of the loss function.

Optionally, in one embodiment, in step 4), deep learning methods are adopted to recognize the content of each subsection; wherein the number of classification categories is 11, which are numbers from 0 to 9 and the symbolic scale “E”.

When the recognition result is reliable, recording the number of each scale and its location at the current moment; when the recognition result is unreliable, reading the historical scale of this monitoring point.

Optionally, in one embodiment, in step 5), the equation for calculating the water level is as follows.

$$WL = label \cdot 10 - \frac{( {y}_{w} - {y}_{l} ) \cdot 5}{{y}_{h} - {y}_{l}}$$

Wherein, WL (cm) is the water level; label is the numerical reading of the scale region; y_{w} is the coordinate of water line; yₗ is the coordinate of the lower edge of the scale region; and yₕ is the coordinate of the upper edge of the scale region.

Compared with the prior art, the present disclosure has the following advantages.

By means of the present disclosure, the image can be directly used as the network input during water level monitoring, avoiding the complicated feature extraction and data reconstruction process in the prior art. The present disclosure may quickly and efficiently identify the water level of the water gauge, and control the error within a certain range.

### BRIEF DESCRIPTION OF THE DRAWINGS

FIG. 1 is an image recognition flow diagram of the water gauge according to embodiments of the present disclosure.

FIG. 2 is an intercepted image of a water gauge area according to embodiments of the present disclosure.

FIG. 3 is a binarization image processed by OTSU according to embodiments of the present disclosure.

FIG. 4 is a flow diagram of K-Means clustering algorithm according to embodiments of the present disclosure.

FIG. 5A-5B are clustering segmentation diagrams; wherein, FIG. 5A is an image after pixel clustering; FIG. 5B is an image after region segmentation.

FIG. 6A-6D are effect images of data enhancement according to embodiments of the present disclosure; wherein FIG. 6A is an unprocessed image; FIG. 6B is a cropped image; FIG. 6C is an image with edge filling; and FIG. 6D is an image with color conversion.

### DETAILED DESCRIPTION OF THE DISCLOSURE

In order to make the objectives, technical solutions and advantages of the present disclosure clearer, the present disclosure will be further described below in conjunction with the embodiments and the accompanying drawings. Obviously, the described embodiments are a part of the embodiments of the present disclosure, rather than all of the embodiments. Based on the described embodiments, all other embodiments obtained by a person of ordinary skill in the art without creative work shall fall within the protection scope of the present disclosure.

Unless otherwise defined, the technical or scientific terms used in the present disclosure shall have the usual meanings understood by those with ordinary skills in the field to which the present disclosure belongs. Similar words such as “comprises” or “include” used in the present disclosure mean that the element or item appearing before the word covers the elements or items listed after the word and their equivalents, and does not exclude other elements or items. Similar words such as “connected” or “coupled” are not limited to physical or mechanical connections, but may include electrical connections, whether direct or indirect. Terms “up,” “down,” “Left,” “Right,” etc. are only used to indicate the relative position relationship. When the absolute position of the described object changes, the relative position relationship may also change accordingly.

### Embodiment

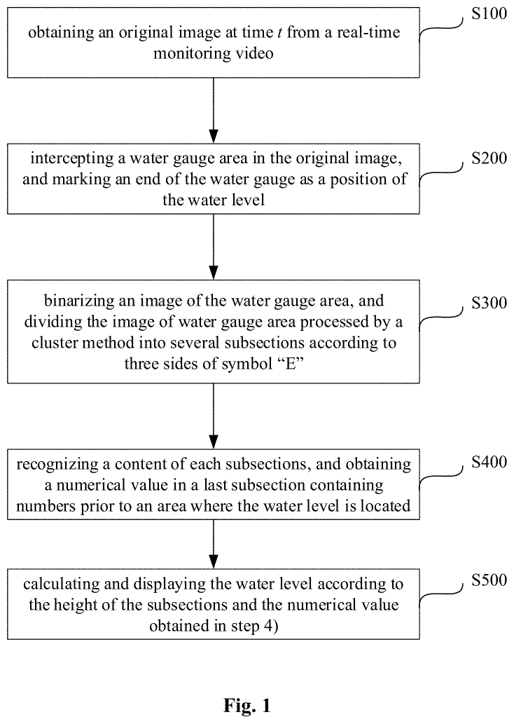

Referring to FIG. 1, the water level monitoring method based on cluster partition and scale recognition comprises the following steps:

S100, obtaining a real-time monitoring video, and obtaining an original image at time t from the real-time monitoring video.

S200, intercepting a water gauge area in the original image, and marking an end of the water gauge as a position of the water level. More specifically:

S201, deep-learning semantic segmentation algorithm Deeplab V3+ is used to intercept the water gauge area.

Deeplab V3+ can be divided into two parts: Encoder and Decoder. The Encoder part is responsible for extracting high-level features from the original image. The Encoder down-samples the image, extracts deep semantic information from the image, and obtains a multi-dimensional feature map with a size smaller than the original image. The Decoder part is responsible for predicting the category information of each pixel in the original image.

S202, performing image data enhancement processing on the intercepted area.

Deep learning requires a large number of data samples to train the neural network model. The reason is to ensure that the data distribution during model training is the same as in actual use to prevent overfitting. On the other hand, semantic segmentation needs to label each pixel of the picture, and the labor cost of labeling is very high. Therefore, during model training, it is necessary to use data augmentation to increase the number of training sets and improve the robustness and generalization ability of the model.

From the classification of implementation methods, there are two types of data enhancement: offline enhancement and online enhancement. In this embodiment, online enhancement is used, and during training, data enhancement is performed on each input picture. The advantage of online enhancement is to enhance the randomness, making the trained model more robust, and does not require additional space.

From the content classification of image processing, image data enhancement can be divided into geometric enhancement and color enhancement. Geometric enhancements include random flips (horizontal, vertical), cropping, and rotation. After the original image is geometrically transformed, its corresponding label must be transformed in the same way. Color enhancement includes random noise, brightness adjustment, contrast adjustment, etc. The noise selects Gaussian noise to generate random noise whose probability density conforms to the Gaussian distribution, as shown in equation (1):

$$p ( i , j ) = ( \frac{p ( i , j )}{255} + normal ( μ , σ ) ) \cdot 255 \qquad ( 1 )$$

Wherein, p(i, j) represents the value of a pixel; normal is the Gaussian distribution; μ is the mean; σ is the standard deviation.

Brightness and contrast are directly adjusted by linear transformation, as shown in equation (2):

p(i,j)=α·p(i,j)+β (2)

Wherein, α adjusts the contrast of the image, and β adjusts the brightness of the image.

Data enhancement makes the input image more diverse and improves the generalization performance of the model.

S203, model training.

In this embodiment, the number of training sets is 450, and the number of test sets is 50. The training platform is Ubuntu 16.04, and the GPU is a single card GTX 1080 Ti (11 GB). First, set the hyper-parameters, and then perform normalization preprocessing on the data.

S204, semantic segmentation effect evaluation.

The standard metric of the semantic segmentation task in this embodiment adopts MIoU (Mean Intersection over Union) according to image characteristics, wherein IoU refers to the area of the intersection of two point sets compared to the area of the union of the two. MIoU is the mean value of IoU between the true value and the predicted value of each category, as shown in equation (3):

$$MIoU = \frac{1}{k + 1} {\sum }_{i = 0}^{k} \frac{{P}_{ii}}{{\sum }_{j = 0}^{k} {P}_{ij} + {\sum }_{j = 0}^{k} {P}_{ji} - {P}_{ii}} \qquad ( 3 )$$

Wherein, k represents the number of categories; Pⱼᵢ represents false positives, that is, the prediction is wrong: the prediction result is positive while the true result is negative; Pᵢᵢ represents right positives, that is, the prediction is right: the prediction result is positive and the true result is positive, too; Pᵢⱼ represents false negatives, that is, the prediction is wrong: the prediction result is negative while the true result is positive; i represents true value, j represents prediction value.

S205, extracting the water gauge area for correction, and solves the problem of the shooting angle and shooting distance of the water gauge.

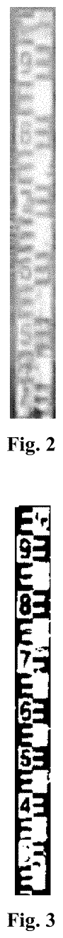

S206, after the water gauge is divided, the main body of the water gauge is intercepted by a rectangular area, as shown in FIG. 2, which can be used as an input for scale recognition, and the position of the end of the water gauge is used as the coordinates of the water level line. In addition to dividing the water gauge, the accuracy of the lower edge position of the water gauge segmentation also directly affects the accuracy of water level recognition.

S300, image data is pre-processed and divided into several regions by clustering method. Image binarization and cluster partitioning are required. More specifically:

S301, image binarization.

Converting the image from an RGB three-channel image to a single-channel grayscale image. Using the brightness (Luma) equation specified by CCIR 601 to calculate the image brightness, as shown in equation (4):

Grey=0.299R+0.587G+0.114B (4)

The OTSU method used in image binarization in this embodiment is a commonly used global threshold algorithm, also known as the maximum between-class variance method. According to the threshold T, the pixels are divided into foreground (1) and background (0). The calculation equation for the variance between classes is shown in equation (5):

Var=N₁(μ−μ₁)²+N₀(μ−μ₀)² (5)

Wherein, N₁ is the number of pixels in the foreground; μ₁ is the average value of pixels; N₀ is the number of background pixels; μ₀ is the average pixel value; and μ is the average value of all pixels. Using the traversal method, the threshold is traversed from 0 to 255, and the threshold T when the variance Var is maximum is recorded, and the threshold T is calculated as 180 using the OTSU method. Using this threshold to binarize the water gauge image, the result is shown in FIG. 3.

S302, clustering partition.

According to the result of binarization, the image is divided into several regions. By counting the number of foreground pixels on the y-axis, find the position of the three horizontal lines of the scale symbol E, and then divide the area according to the distance between the horizontal lines. The core algorithm used here is the K-Means clustering algorithm. The flow of the K-Means algorithm is shown in FIG. 4, including the following steps:

b) calculating the distance from all points to the K cluster centers;

c) classifying each point and its nearest cluster center into one category;

d) in each new category, finding the point with the smallest distance within the category as the new cluster center; and

e) repeating steps b-d until the number of iterations is completed, and iterate to the end of the set value of the loss function.

In this embodiment, the Manhattan distance equation is used for calculation, as shown in equation (6):

distₘₐₙ(x₁,x₂)=|x₁−x₂|² (6)

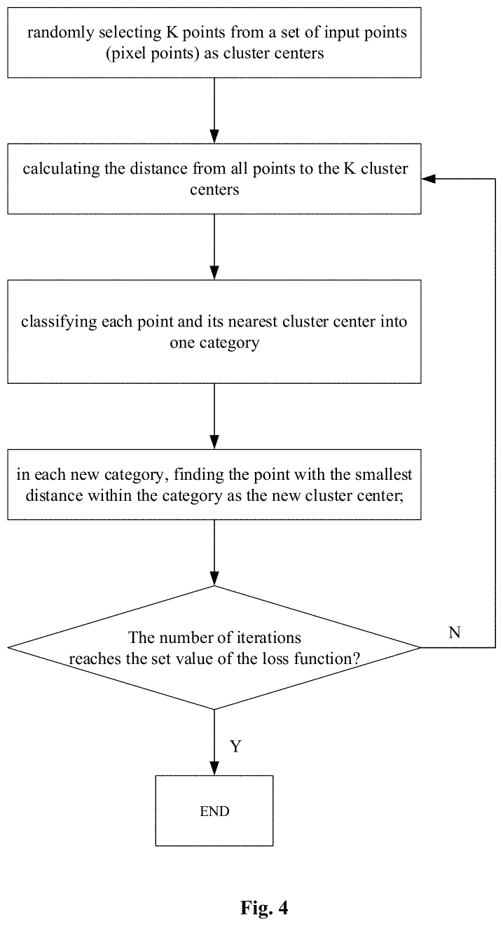

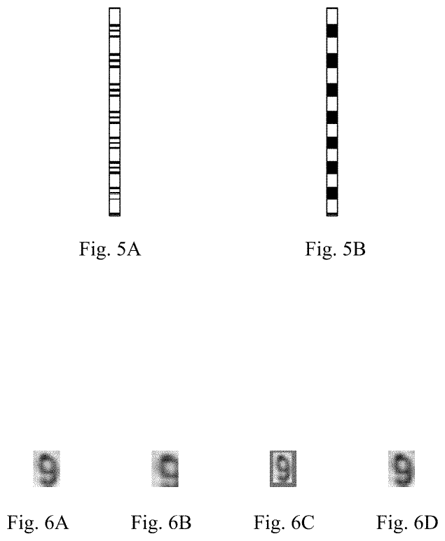

Cluster the number of foreground pixels on the y-axis of the image, the number of cluster centers K=2, divide the y-axis of the image into two categories, and mark the area corresponding to the category with a larger number of foreground pixels as black, and the number of foreground pixels is larger Less marks are white, as shown in FIG. 5A. It can be seen from the figure that the black area corresponds to the three sides of the scale symbol “E” in the original image, and the distance between scale symbols is greater than the distance within the symbol. Calculate the spacing of all black areas. The spacing within the symbol “E” is smaller than the spacing between the symbols, which is about 1:3. Then carry out K=2 mean clustering on the spacing, and get two cluster centers, which are the adjacent symbol spacing and the intra-symbol spacing. According to the distance, the black edges belonging to a symbol are merged into one area, and the result is shown in FIG. 5B.

S400: identifying the content of each area, including determining model structure, data enhancement and model training. At the end, the value of the previous area containing numbers in the area where the water level is located is obtained. More specifically:

S401, model structure

The image classification algorithm in deep learning is used to classify each region. The image conversion and binarization in step S301 are only used for clustering and partitioning. The input of the classification network is a three-channel RGB image. The number of classification categories is 11, which are numbers 0-9 and scale symbol E. The convolutional neural network used in this embodiment is composed of seven 3×3 convolutional layers, three 2×2 pooling layers and one fully connected layer, and its network structure is shown in Table 1.

TABLE 1
Classification Network Structure

| Layer | Kernel | Output feature |
|---|---|---|
| Input | \ | [3, 28, 28] |
| Conv1_1 | [3, 16, 3, 3], s = 1, p = 1 | [16, 28, 28] |
| Conv1_2 | [16, 16, 3, 3], s = 1, p = 1 | [16, 28, 28] |
| MaxPool1 | [2, 2], s = 2, p = 0 | [16, 14, 14] |
| Conv2_1 | [16, 32, 3, 3], s = 1, p = 1 | [32, 14, 14] |
| Conv2_2 | [32, 32, 3, 3], s = 1, p = 1 | [32, 14, 14] |
| MaxPool2 | [2, 2], s = 2, p = 0 | [32, 7, 7] |
| Conv3_1 | [32, 64, 3, 3], s = 1, p = 1 | [64, 7, 7] |
| Conv3_2 | [64, 64, 3, 3], s = 1, p = 1 | [64, 7, 7] |
| Conv3_3 | [64, 64, 3, 3], s = 1, p = 1 | [64, 7, 7] |
| MaxPool3 | [2, 2], s = 2, p = 1 | [64, 4, 4] |
| Flatten | / | 1024 |
| Full Connection | [1024, 11] | 11 |

S402, data enhancement.

Semantic segmentation and clustering are performed on all water gauge images, and the images of all regions are cropped. After being manually labeled, it serves as the training set and test set of the image classification task. Among them, 5000 sheets are in the training set and 500 sheets in the test set, a total of 5500 sheets. The 11 categories are evenly distributed, with 500 sheets in each category.

The image classification task has a large amount of data, lower training difficulty, and less reliance on data enhancement. The data enhancement used in the classification experiment in this example includes random cropping, scaling, noise addition, color space conversion, etc., all of which are randomly enhanced with a probability of 0.5. The enhancement effect of the image data is shown in FIGS. 6A-6D.

Among them, the enhancement effect of cropping and adding noise is shown in FIG. 6B.

Scaling is to fill pixels at the edges of the image, and then scale the image to its original size. The image is reduced by ensuring that the input size of the neural network is fixed. Therefore, cropping is equivalent to magnifying the image, and edge filling is equivalent to reducing the image. The pixel value used for filling is (123, 116, 103), which is 255 times the normalized mean value of the input, which is close to 0 after normalization. The enhancement effect is shown in FIG. 6C.

Color space conversion refers to converting the R channel and B channel of an image. Because the scale of the water gauge has two kinds of blue and red, and the number of red is more than that of blue. Randomly switching between R channel and B channel with a probability of 0.5 can keep the red and blue samples in the training data balanced, and the enhancement effect is shown in FIG. 6D.

The data enhancement in the classification task will not affect the true value.

S403, model training.

The number of training sets: 5000, the number of test sets: 500. The training platform is Ubuntu 16.04, and the GPU is GTX 1080 Ti (11 GB).

Hyperparameter settings: the network input size is 28×28, the batch size is 64, and the training epoch is 35. The normalized mean is (0.485, 0.456, 0.406), and the normalized standard deviation is (0.229, 0.224, 0.225). Momentum is selected for the optimization algorithm, and γ is 0.9. The initial learning rate is 0.01, and the learning rate decay method is gradient decay. After training for 20 epochs, the learning rate decays to 0.001. The loss function uses softmax loss. Compared with the water rule segmentation, the number recognition is simpler, and the loss converges to 0.0001.

S404, evaluation index.

The evaluation index for multi-classification tasks is mainly Accuracy (accuracy), and the equation is shown in equation (7):

$$a c c = \frac{{\sum }_{i = 0}^{N} {T}_{i}}{N} \qquad ( 7 )$$

Wherein, N is the number of test set; T is 1 when the classification is right, and 0 when it is wrong.

S500, calculating and displaying the water level according to the size of the area and the classification result. More specifically:

In the scale recognition module, the classification labels and scores of several regions are output. A threshold (threshold=0.95) is preset to filter out areas with lower scores. These filtered areas are usually fuzzy and cannot accurately determine the type of area to prevent interference with the results.

On the water scale, there is a certain relationship between the categories of each area. For example, the next area of the number “6” must be the scale symbol “E”, and the next area must be the number “5”. If the area under the number “6” is classified as “4”, then the classification result of at least one of the two areas is wrong. Based on this relationship, the design algorithm selects the most reliable classification result.

If the reliable classification result exceeds 50%, record the classification result. If it is less than 50%, the historical classification result is used to calculate the water level. The corresponding measured height of each area on the water ruler is 5 cm. According to the height of the correctly classified area in the image, the scale of the image can be calculated to calculate the specific number of scales of the water level line. The equation is as follows:

$$WL = label \cdot 10 - \frac{( ( {y}_{w} - {y}_{l} ) \cdot 5 )}{{y}_{h} - {y}_{l}} \qquad ( 8 )$$

Wherein, WL (cm) is the water level; label is the numerical reading of the scale region; y_{w} is the coordinate of water line; yₗ is the coordinate of the lower edge of the scale region; and yₕ is the coordinate of the upper edge of the scale region.

What is claimed is:

1. A water level monitoring method based on cluster partition and scale recognition, comprising the following steps:
1) obtaining an original image at time t from a real-time monitoring video;
2) intercepting a water gauge area in the original image, and marking an end of the water gauge as a position of the water level;
3) binarizing an image of the water gauge area, and dividing the image of water gauge area processed by a cluster method into several subsections according to three sides of symbol “E”;
4) recognizing a content of each subsections, and obtaining a numerical value in a last subsection containing numbers prior to an area where the water level is located; and
5) calculating and displaying the water level according to the height of the subsections and the numerical value obtained in step 4).

2. The water level monitoring method according to claim 1, wherein in step 2), semantic segmentation algorithm Deeplab V3+ is used to divide the original image, comprising:
2-1) obtaining a training set, and performing data enhancement and normalization processing on images in the training set;
2-2) inputting the processed image into Deeplab V3+ semantic segmentation model for training, and outputting a first segmentation result;
2-3) evaluating the first segmentation result to obtain a segmentation model of the water gauge area; and
2-4) inputting the original image into the segmentation model of the water gauge area to obtain a second segmentation result, and correcting the second segmentation result.

3. The water level monitoring method according to claim 2, wherein in the step 2-3), when evaluating the first segmentation result, MIoU (Mean Intersection over Union) is adopted according to the characteristics of the image, wherein IoU (Intersection over Union) refers to a ratio of the area of the intersection of the two point sets to the area of the union of the two point sets; MIoU is the mean value of the IoU of the true value and the predicted value of each category. MIoU is shown as following equation:
$$MIoU = \frac{1}{k + 1} {\sum }_{i = 0}^{k} \frac{{P}_{ii}}{{\sum }_{j = 0}^{k} {P}_{ij} + {\sum }_{j = 0}^{k} {P}_{ji} - {P}_{ii}} ;$$
the segmentation result is classified by the evaluation result.

4. The water level monitoring method according to claim 1, wherein in step 3), OTSU is adopted to binarize the image of the water gauge area, comprising:
dividing a pixel into a foreground 1 and a background 0 according to a threshold T, wherein a calculation equation for the variance between classes is:
Var=N₁(μ+μ₁)²+N₀(μ−μ₀)²_{;}
wherein, N₁ is the number of pixels in the foreground; μ₁ is a mean value of the pixels in the foreground; N₀ is the number of pixels in the background; μ₀ is a mean value of the pixels in the background; μ is a mean value of all pixels;
traversing the threshold value from 0 to 255 by traversal methods; recording a threshold value T when the variance Var reaches maximum; calculating the threshold value T by OTSU method; and binarizing the image of the water gauge area with the threshold value.

5. The water level monitoring method according to claim 1, wherein the step 3) further comprises:
3-1) counting the number of foreground pixels on the y-axis according to the binarization result;
3-2) marking the area corresponding to the category with a larger number of foreground pixels as black, and marking the area with a smaller umber of foreground pixels as white;
3-3) calculating the spacing of all black areas, wherein the spacing between the three sides of the symbol “E” is less than the spacing between the numerical symbols;
3-4) performing K=2 mean clustering on all spacings, and obtaining two cluster centers;
wherein the two cluster centers are the spacing between adjacent “E” symbols and the three-side spacing of “E” symbols;
3-5) combining a black borders of the three sides that belong to the “E” symbol into one area and marking the area as black to complete the segmentation of the several subsections consisting of the black areas and white areas.

6. The water level monitoring method according to claim 5, wherein K-means clustering algorithm is adopted as a key algorithm in the step 3-4); the step 3-4) comprises:
a) randomly selecting K points from a set of input points (pixel points) as cluster centers;
b) calculating the distance from all points to the K cluster centers;
c) classifying each point and its nearest cluster center into one category;
d) in each new category, finding the point with the smallest distance within the category as the new cluster center; and
e) repeating steps b-d until the number of iterations is completed, and iterate to the end of the set value of the loss function.

7. The water level monitoring method according to claim 1, wherein in step 4), deep learning methods are adopted to recognize the content of each subsection; wherein the number of classification categories is 11, which are numbers from 0 to 9 and the symbolic scale “E”;
when the recognition result is reliable, recording the number of each scale and its location at the current moment; and
when the recognition result is unreliable, reading the historical scale of this monitoring point.

8. The water level monitoring method according to claim 1, wherein in step 5), the equation for calculating the water level is as follows.
$$WL = label \cdot 10 - \frac{( {y}_{w} - {y}_{l} ) \cdot 5}{{y}_{h} - {y}_{l}} ;$$
wherein, WL (cm) is the water level; label is the numerical reading of the scale region; y_{w} is the coordinate of water line; yₗ is the coordinate of the lower edge of the scale region; and yₕ is the coordinate of the upper edge of the scale region.
